(19) United States
(12) Patent Application Publication
(10) Pub. No.: US 2026/0099386 A1
(43) Pub. Date: Apr. 9, 2026

(54) Efficient and Secure Execution of Computerized Tasks in a Networked System

(71) Applicant: Bank of America Corporation, Charlotte, NC (US)

(72) Inventors: George Albero, Charlotte, NC (US); Maharaj Mukherjee, Poughkeepsie, NY (US)

(21) Appl. No.: 18/910,476

(22) Filed: Oct. 9, 2024

(51) Int. Cl. G06F 9/50

(52) U.S. Cl. CPC G06F 9/5083

(57) ABSTRACT

Processing of computerized tasks may be performed by dividing the task into multiple sub-tasks. Further, multiple instances or copies of each sub-task may be transmitted using different transport containers or receptacles to provide redundancy and to thereby increase the reliability of task processing in a networked environment. Additionally, each route taken by each instance of the sub-task may be randomized. Randomization may enhance the security of the task processing.

### BACKGROUND

Aspects described herein relate to electrical computers, systems, and devices for analyzing computer-and network-based processing tasks and coordinating the performance and completion of those tasks in an efficient, secure, and reliable manner.

Existing technology infrastructures for performing various computing tasks often involve a network of devices such as proxy-servers, web-servers, load balancers, local traffic managers, global traffic managers, database-servers, and the like. Each of these servers, managers, computing devices and the like may perform different functions and have different responsibilities. In some examples, these devices, modules, and systems may have different capabilities and/or hardware components. If any of these devices, modules, and systems malfunction, or become overloaded relative to their allowable capacity, they may not be able to handle the traffic of computing tasks which may, in turn, create a significant slowdown of jobs or complete outage of the network. In other cases, if network connections between any of these devices, modules or systems become congested or fail, computing tasks may not be completed in an efficient or otherwise expected manner, or at all.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide a device, system, and process for coordinating and managing the completion of computing tasks in a computer-based network environment. Coordinating and managing the completion of tasks may include determining and generating multiple sub-tasks that are required for the completion of an overall task. For example, when network congestion is detected, a network service provider may be required to reroute communications from device A to device B through different connections. This task (i.e., rerouting communications) may be divided into sub-tasks such as (a) identifying a congested network connection, (b) identifying a network connection that has sufficient bandwidth and latency, and (c) directing a router to transmit communications through the identified network connection instead of the congested network connection. In another example, processing payments through a payment network may include sub-tasks such as (a) verifying an identity of the payor, (b) confirming the payment method (e.g., credit card number, bank account information, etc.), (c) initiating a transfer of funds to a payee, and (d) confirming payment (e.g., to a vendor or a recipient of the payment). Each of these sub-tasks may be performed by the same computing device or different computing devices, and require communication of instructions and information over one or more network connections. By dividing an overall task into sub-tasks, a system may improve processing efficiency by having the sub-tasks performed in parallel. Additionally or alternatively, use of sub-tasks may allow a system to only restart certain steps of the overall task upon detecting a failure, instead of having to restart the entirety of the task process. That is, sub-tasks may provide further granularity for monitoring and managing the completion of the task process.

According to one or more aspects, a task processing system may create multiple instances or copies of the same sub-task and transmit each instance or copy along a communication route. This may provide redundancy to ensure that at least one instance of the sub-task is received by a destination device, system, module or node.

According to one or more additional aspects, communication routes of each sub-task (or each instance of the sub-task) may be randomly selected and/or selected using various types of algorithms. Because at least some of the communication routes from the source to the destination may be different, e.g., using randomized assignment, the system may be able to improve the probability that at least one of the sub-tasks reaches the intended destination for processing. Randomizing the communication routes or assigning the routes in a non-deterministic manner may further enhance the security of the communications, e.g., to subvert man-in-the-middle type attacks.

According to further aspects, a task processing system may cause one or more of the multiple instances or copies of the same sub-task to be deleted upon determining that one instance or copy of the sub-task has been successfully received by a destination node. In some examples, the system may cause deletion of the other instances or copies upon determining that processing of the one instance or copy of the sub-task by the destination device or node has begun. In other examples, deletion may occur upon determining that processing of the instance or copy of the sub-task has been completed.

According to one or more aspects, multiple different sub-tasks may be performed by the same node or device or system. Additionally or alternatively, different sub-tasks may be performed in parallel or sequentially. For example, processing of some sub-tasks may require completion of another sub-task (e.g., for input data or the like), and thus, those sub-tasks might not be transmitted or initiated until the other sub-task has been completed.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for a task processing management system and service in accordance with one or more aspects described herein;

FIG. 2A illustrates an example network architecture for task processing in accordance with one or more aspects described herein;

FIG. 2B illustrates an example process flow for task processing in accordance with one or more aspects described herein;

FIG. 3 is a flowchart illustrating an example method for processing and managing a requested computerized task according to one or more aspects described herein;

FIG. 4 depicts an example method for managing the processing of a sequence of sub-tasks and the completion of an overall task according to one or more aspects described herein; and

FIG. 5 depicts an illustrative architecture and operating environment for a task processing management system according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, computing processes often require or use computing resources that may exist across a communication network. To coordinate the completion of these computing processes, or tasks, a system may need to transmit information such as commands, instructions, data, specifications, and the like, to other devices, systems, modules, and/or nodes through the network. In some instances, portions of the network may fail or experience undesirable conditions such as congestion, increased latency, link or device failure, and the like. In such situations, the processing of the tasks may either fail, be significantly slowed, or otherwise be negatively impacted. Accordingly, in some examples, a task may need to be restarted from the beginning, or a task requester may need to wait longer for task completion, creating delays and inefficiencies.

Accordingly, aspects described herein provide systems and methods for improving the efficiency of processing computing tasks within a networked environment. In one or more arrangements, the systems and methods may include identifying and generating sub-tasks corresponding to an overall task. These sub-tasks may be portions of the overall task that must be completed before the overall task is considered finished. By dividing the overall task into sub-tasks, a system and method might not be required to restart the task from the beginning if a particular sub-task fails. Instead, only the failed sub-task might need to be restarted or re-executed. For example, a sub-task may fail if the sub-task fails to reach a destination system, device, module or node that is configured to perform that sub-task. In another example, a sub-task may fail if the destination is overloaded or experiences a system failure. Accordingly, efficiency of task processing may be improved through use of sub-tasks.

According to one or more further aspects, a task or sub-task may be transmitted in multiple transport containers or receptacles in order to increase the likelihood that the task or sub-task reaches the intended destination. For example, each task or sub-task may be replicated and stored in multiple transport receptacles and sent to a destination system, device, module or node for processing of that task or sub-task. Using such a technique, if a network or destination has a period of failure, or a transport container (e.g., a packet) is otherwise lost, the other transport containers containing copies or other instances of the same task or sub-task may allow for recovery of the corresponding process without significant delay. Additionally, if one transport container (or copy of the sub-task) is delayed by network congestion, other copies or instances of the sub-task carried by other transport containers may provide the opportunity for the other instances of the sub-task (via the other transport containers) to reach a destination processing device in a timelier fashion despite the network congestion experienced by the one transport container.

In yet another aspect, the transport routes for each receptacle containing the same task or sub-task may be assigned randomly or in another fashion. In one example, the transport routes may be determined and assigned so as to be different from one another. Use of different routes may further improve the probability that at least one instance of the task or sub-task reaches its intended destination and is processed and completed. In other examples, the routes may be randomly selected (e.g., assigning the routes in a non-deterministic manner) at the source or a next hop may be randomized at each router, gateway, node, device, or the like along a route. Randomization may increase the security of the communications.

According to further aspects, if a task or sub-task is sent in multiple transport receptacles, once the system is notified that at least one of the instances of the task or sub-task has been received by the intended destination, all other instances of the task or sub-task may be deleted or otherwise not processed. In some examples, multiple systems, devices, nodes, or modules may exist in the network for performing a particular task or sub-task. Accordingly, different instances of the task or sub-task may be transmitted to different ones of those systems, devices, nodes, or modules. If one instance of the task or sub-task is successfully received and/or processed by one of the systems, devices, nodes, or modules, the system may transmit a command to the other destinations systems, devices, nodes, or modules to delete or not process their copy or instance of the task or sub-task.

These and various other arrangements will be discussed more fully below.

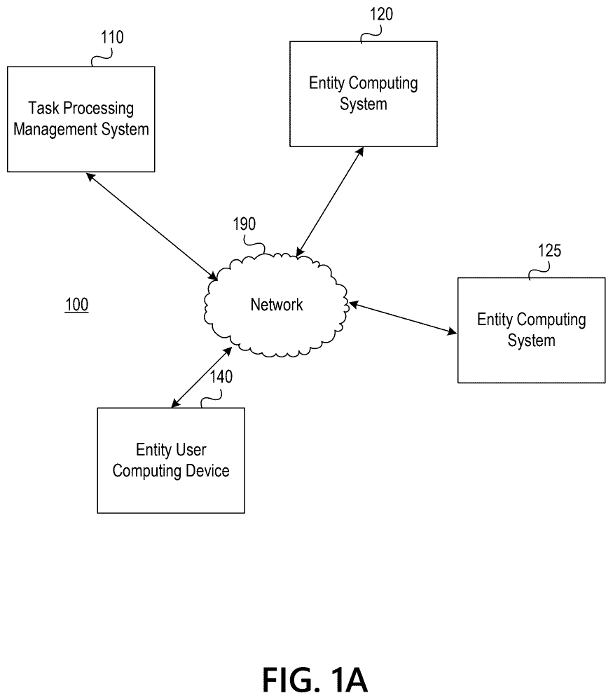

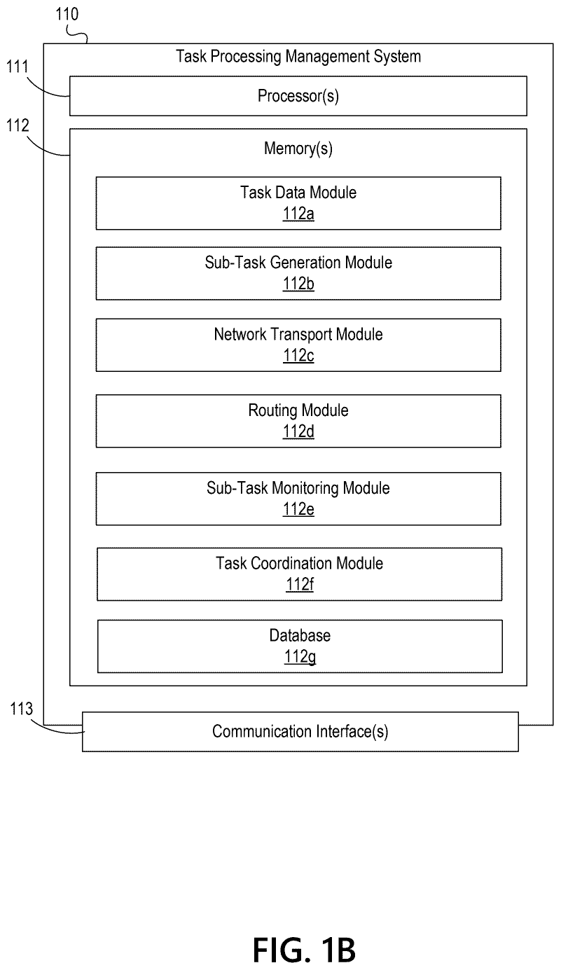

FIGS. 1A-1B depict an illustrative computing environment for implementing a task processing management system and process in accordance with one or more aspects described herein. Referring to FIG. 1A, computing environment 100 may include one or more computing devices and/or other computing systems. For example, computing environment 100 may include task processing management system 110, entity computing system 120, entity computing system 125 and entity user computing device 140. Although two entity computing systems 120, 125 and one entity user computing device 140 are shown, any number of systems or devices may be used without departing from the invention.

Task processing management system 110 may be or include one or more computing devices (e.g., servers, personal computers (PCs), routers, mobile devices, server blades, or the like) and/or one or more computing components (e.g., memory, processor, and the like) and may be configured to receive or otherwise determine tasks that need to be performed and completed. These tasks may include various types of computing tasks including network management tasks, computer modeling tasks, system maintenance tasks, communications processing tasks, financial processing tasks, and the like. Additionally, in some arrangements, the task processing management system 110 may generate alerts, recommendations, information, reports, notifications and commands relating to the computing tasks. Such alerts, commands, and the like may be provided to another device (e.g., entity user computing device 140 and/or entity computing systems 120, 125). The other device may include one or more of a device from which a task request was received, a user device configured to monitor task processing, a system for logging, reporting, and monitoring task processing statuses, and the like and/or combinations thereof. In some examples, the alerts, reports, and/or notifications may be transmitted to the entity user computing device 140 and/or entity computing systems 120, 125 to cause those devices to execute one or more commands. The other device may then be controlled to execute the command (e.g., display an alert or terminate an interaction or process, execute security script to log transactions, execute security code to limit functionality, etc.) in response to receiving the communication from the task processing management system 110. In one example, if a task or sub-task fails, the task processing management system may send a command to entity user computing device 140 (e.g., a device that requested the task) to terminate a process or transaction (e.g., a network management process, a financial transaction, etc.) associated with that task.

In one arrangement, task processing management system 110 may be configured to identify and generate sub-tasks based on receiving a request for a task to be processed or completed. These task requests may be received from various local or remote network devices (e.g., entity user computing device 140 and/or entity computing systems 120, 125) and/or locally from a user of the system 110. In one or more arrangements, the task processing management system 110 may receive a set of instructions, commands, or code and identify logical separations in the instructions, commands, or code. Those logical separations may be designated in the task request (e.g., by virtue of code comments, specific code fragments, intentional delineations such as formatting, numbering, and the like). In some examples, the task processing management system 110 may use an artificial intelligence and machine learning model to identify logical separations in the instructions or code where sub-tasks. The task processing system 110 may then generate separate instructions, commands, code and the like for each sub-task.

The task processing management system 110 may further determine one or more computing devices configured to perform each of the sub-tasks. For example, the task processing management system 110 may include a list or database of computing devices, systems, modules and/or network nodes that have various types of capabilities, functionalities, and the like. In some arrangements, the database or list may further include capability or functionality information as well as a current status of the various devices, systems, modules, and nodes. The task processing management system 100 may then determine where or at what device, system, module, and/or node each sub-task will be processed based on the database or list of capability and status information. In some examples, one or more processing devices, systems, modules and/or nodes may be specified as part of the task request. Once the task processing management system 100 has made the determination, the task processing management system 100 may generate or otherwise cause to be generated transport containers or receptacles for each sub-task for transmission to the intended destination device, system, module, and/or node.

According to some aspects, the task processing management system 100 may generate multiple transport receptacles or containers for each sub-task such that multiple instances or copies of the sub-task are provided. Each of these instances may then be transmitted to the intended destination or intended destinations (e.g., if there are multiple devices, systems, modules, and/or nodes that can perform the required sub-task). The number of receptacles (and thus, instances or copies of the same sub-task) may be determined based on various factors including current network conditions (e.g., network congestion), number of available task processing servers, security required for the task, and the like and/or combinations thereof. For example, if there is high network congestion, more copies of the same sub-task may be generated. In another example, if a security level required for the task is high, less copies or instances may be generated and used for task processing.

Prior to transmission, the task processing management system 100 may determine transport paths or routes for each instance of the sub-task (i.e., for each transport receptacle or container). In some examples, the task processing management system 100 may randomly assign transport routes (e.g., assign the routes in a non-deterministic manner) and/or assign transport routes that are different from one another. In other examples, the task processing management system 100 may initially randomly assign transport routes to each of the transport containers storing the same sub-task, and subsequently determine that at least a threshold number of different paths exist among the initially-assigned routes. In still other examples, the transport processing management system 100 may first select a number of different transport paths and subsequently assign those paths to the multiple transport receptacles.

Entity computing system 120 and/or entity computing system 125 may be or include one or more computing devices (e.g., servers, routers, gateways, network nodes, personal computers (PCs), mobile devices, server blades, or the like) and/or one or more computing components (e.g., memory, processor, and the like) and may be configured to host or execute one or more applications or systems. For instance, entity computing system 120 and/or entity computing system 125 may host or execute internal or user-facing applications or systems that may be accessed by one or more users in-person or remotely, such as via a network, including private networks, public networks, or the like, and/or combinations thereof. Entity computing system 120 and 125 may be terminals operated by a customer for providing products or services, general purpose computing devices providing function-specific applications, and/or function-specific devices such as database servers, machine learning engines, automated teller machines (ATMs), maintenance devices, electronic vaults, cash registers, points of sale system, and the like and/or combinations thereof. The entity computing system 120 and/or 125 may further be used to input or request performance of one or more tasks by a customer or user external to an organization.

Entity user computing device 140 may be or include a computing device such as a desktop computer, laptop computer, tablet, smartphone, wearable device, and the like, that is associated with a user (e.g., an employee) of an organization. Entity user computing device 140 may communicate with task processing management system 110 and/or entity computing systems 120, 125 to receive notifications and other information associated with requested tasks. In some arrangements, the entity user computing device 140 may be used to input or request tasks associated with the organization. In other examples, the entity user computing device 140 may be used to confirm or approve task requests inputted through one or more other devices or by other users such as through entity computing system 120 and/or 125.

As mentioned above, computing environment 100 also may include one or more networks, which may interconnect one or more of task processing management system 110, entity computing system 120, entity computing system 125, and/or entity user computing device 140. For example, computing environment 100 may include network 190. Network 190 may include one or more sub-networks (e.g., Local Area Networks (LANs), Wide Area Networks (WANs), or the like). Network 190 may be associated with a particular organization (e.g., a corporation, financial institution, educational institution, governmental institution, or the like) and may be a private network interconnecting one or more computing devices associated with the organization. For example, task processing management system 110, entity computing system 120, entity computing system 125, and/or entity user computing device 140 may be associated with an organization (e.g., a financial institution), and network 190 may be associated with and/or operated by the organization, and may include one or more networks (e.g., LANs, WANs, virtual private networks (VPNs), or the like) that interconnect task processing management system 110, entity computing system 120, entity computing system 125, and/or entity user computing device 140 and one or more other computing devices and/or computer systems that are used by, operated by, and/or otherwise associated with the organization. Additionally or alternatively, network 190 may be a public network, such as the internet, that may connect the systems and devices described. In yet other examples, network 190 may include a combination of public and private networks.

Referring to FIG. 1B, task processing management system 110 may include one or more processors 111, memory 112, and communication interface 113. A data bus may interconnect processor(s) 111, memory 112, and communication interface 113. Communication interface 113 may be a network interface configured to support communication between task processing management system 110 and one or more networks (e.g., network 190, or the like). Memory 112 may include one or more program modules having instructions that when executed by processor(s) 111 cause task processing management system 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of task processing management system 110 and/or by different computing devices that may form and/or otherwise make up task processing management system 110.

For example, memory 112 may have, store and/or include task data module 112a. Task data module 112a may be configured to collect and/or store information about requested tasks including a requester, an identifier, a status, corresponding sub-task information (e.g., number of sub-tasks, identifiers of the sub-tasks, devices performing the sub-tasks, etc.), historical task information (e.g., completion rate, successful transport paths, etc.), task code or instructions, and the like. This data may be used to estimate time of completion for on-going tasks or sub-tasks, determine whether sub-tasks or tasks need to be restarted, identify transport routes that have higher reliability (e.g., lower percentage of downtime), identify processing devices, systems, modules or nodes that have a higher reliability and/or faster completion time, select transport routes and/or processing devices, systems, modules or nodes, and the like. The task data module 112a may also collect and/or store security information such as security tokens, private/public keys, other encryption information, and the like.

Task processing management system 110 may further have, store and/or include sub-task generation module 112b. Sub-task generation module 112b may be configured to identify an overall processing task to be performed, and to determine one or more subprocesses or sub-tasks within the overall processing task. In some examples, the completion of all sub-processes or sub-tasks may be required in order to complete the overall processing task. The sub-task generation module 112b may identify and generate sub-tasks by analyzing the code or instructions associated with the overall task. In some examples, the overall task may include computer-executable code. The computer-executable code may include code portions or fragments that are delineated by a non-executing comment or other indicator. Other indicators may include particular commands, code statements, invocation of libraries or functions, formatting of the code, and the like and/or combinations thereof. In one example, a code comment such as “#subtask” or “#task1” may be used to identify segments of the code that may be sub-divided into sub-tasks. In other examples, the code may identify specific servers, nodes, systems, or devices that are to be used (or called) to process that portion of the code. Accordingly, in those cases, the system may divide the overall task into sub-tasks based on which server, node, system, or device is identified as being responsible for processing a corresponding portion of code or instructions. Dividing an overall task into sub-tasks may, alternatively or additionally, account for the computational intensiveness of a particular segment of code or instructions or steps. The generation module 112b may divide the overall task to balance the computational intensiveness between all segments.

The sub-task generation module 112b may create separately-executable code files or other data elements for each segment or portion identified in the overall task code. The sub-task generation module 112b may be responsible and configured to name or otherwise apply an identifier to the code and to track a sequence of the sub-task code within the overall task code. In some arrangements, the code files or data element may include an instruction to provide a result (e.g., an output) of the sub-task process to the task processing management system 110 or another entity (e.g., another device, system, module or node). In some examples, the result may be provided to a device, system, module or node that is responsible for processing a sub-task that sequentially follows the sub-task that the current device, system, module, or node has completed processing.

Additionally, task processing management system 110 may have, store and/or include a network transport module 112c. Network transport module 112c may be configured to create transport receptacles or container (e.g., packets or the like) in which the sub-tasks may be transported to an intended destination device, system, module or node. In one or more arrangements, the network transport module 112c may create multiple transport receptacles for each sub-task in order to provide redundancy. That is, transmitting multiple copies of the sub-task to a destination node may help ensure that at least one copy of the sub-task is received and processed. Otherwise, if a network connection through which a single copy of the sub-task is transmitted fails, the sub-task might not be received by the intended destination, properly processed, or completed, leading to delays and errors in the processing of the overall task. In some examples, the network transport module 112c may store copies of the sub-task code into the payload (or other portion) of the separate transport receptacles.

In generating multiple transport receptacles for each sub-task, the network transport module 112c may invoke a routing module, which is described in further detail below, to assign a network transport path. The network transport path may define which nodes, routers, servers, gateways that a packet or other receptacle is directed through in order to reach its specified destination. In some examples, it may be desirable or preferable that each of the transport receptacles for a sub-task is assigned a different network transport path to maximize the probability that at least one copy of the sub-task reaches the intended destination for processing.

Routing module 112d may be configured to determine a network communication route through which a transport receptacle carrying a sub-task is to be transmitted. The route may include one or more routers, nodes, firewalls, gateways, servers, and the like. In some examples, the routing module 112d may identify multiple communication pathways between a source (e.g., a sender of the sub-task) and a destination (e.g., a node, system, device, server, etc. configured to process the sub-task). The routing module 112d may then randomly select one of the identified communication pathways for each of the transport receptacles of a particular sub-task. Routing module 112d may also consult the task data module 112a to identify more successful or reliable network paths when specifying routes for the multiple transport receptacles for a corresponding sub-task.

In some examples, the routing module 112d may specify in the transport receptacle that a transport route is to be randomized. In such instances, the next hop (e.g., next node, device, gateway, router, etc.) in the route may randomly select a subsequent hop. Of course, when the subsequent hop is the intended destination, the current node may simply direct the receptacle to the destination device, system, node, or module without randomization. In one or more arrangements, each path may be chosen such that the next hop (or intended destination) is reachable using that path in a directed acyclic graph (DAG) of the infrastructure.

Task processing management system 110 may have, store and/or include a sub-task monitoring module 112e. Sub-task monitoring module 112e may be configured to monitor the status of each sub-task. For example, the sub-task monitoring module 112e may monitor responses from task processing devices, system, node, and/or module. These responses may include an acknowledgment of receipt of the sub-task or task, a task processing start notification or indication, a task processing completion notification or indication, an output of the task processing and the like and/or combinations thereof. In some arrangements, the sub-task monitoring module 112d may be used to provide feedback to the task processing management system regarding whether a sub-task or task needs to be restarted, whether to initiate (e.g., send) another sub-task for processing, whether to delete other copies of the same sub-task and the like. In one example, if sub-tasks must be performed sequentially, the sub-task monitoring module 112e may indicate to the management system that a second subsequent sub-task may be initiated upon receiving confirmation of task processing completion of a first sub-task. Additionally or alternatively, a result or output of the first sub-task may be included in the initiation of the second sub-task (e.g., as input for the processing of the second sub-task).

In some configurations, the sub-task monitoring module 112e may also be responsible for issuing notifications to other systems or users indicating completion, initiation, receipt, and/or failure of a sub-task. The sub-task monitoring module 112e might only report failure if all copies of a sub-task failed to be received by an intended recipient or failed to be successfully processed.

According to some aspects, the task processing management system 110 may also include a task coordination module 112f responsible for coordinating the performance and completion of sub-tasks. For example, and as discussed, the task processing management system 100 may require performance of sub-tasks in a particular sequence or order. For example, one sub-task may need the result or output of another sub-task in order to perform its processes. Accordingly, coordination module 112f may determine an appropriate or necessary sequence of sub-tasks, and indicate when a sub-task is to be transmitted or initiated (e.g., upon determining that a prerequisite sub-task has been completed).

Task processing management system 110 may further have, store and/or include database 112g. Database 112g may store further data, beyond what is stored in or by task data module 112a. For example, database 112f may store and/or other data that enables performance of aspects described herein by the task processing management system 110.

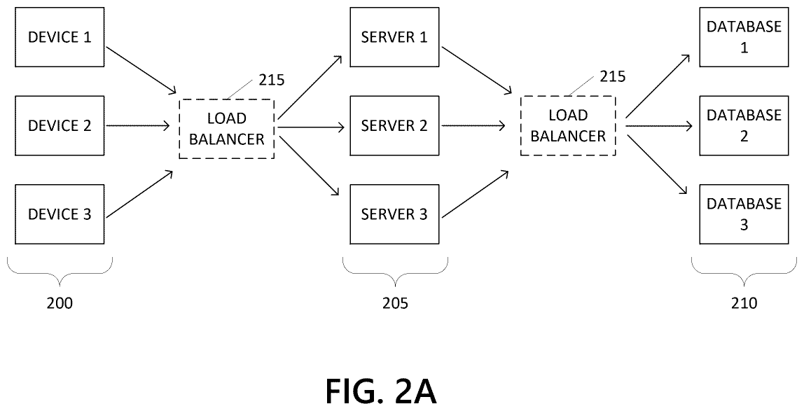

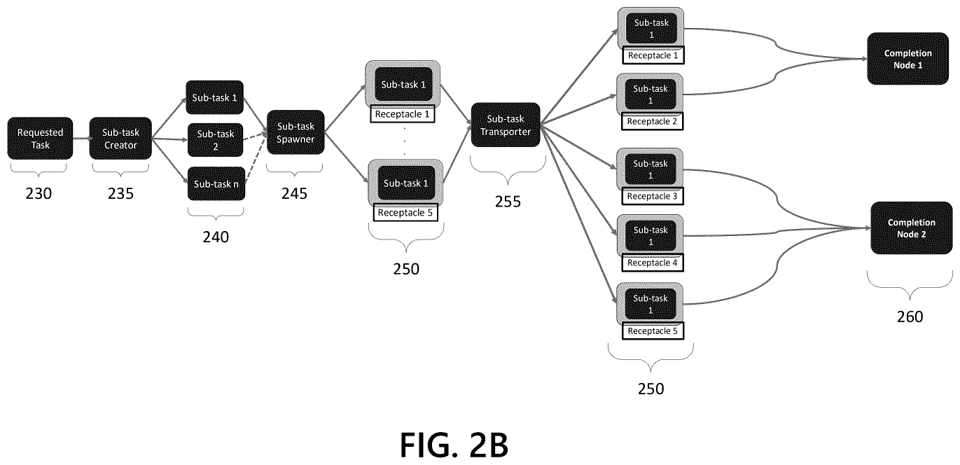

FIGS. 2A and 2B illustrate an example network architecture and flow diagram illustrating a process flow for task processing. FIG. 2A, for example, illustrates a system of network devices that may be used to facilitate the processing of tasks. Devices 200 may correspond to one or more computing devices through which a task may be initiated or otherwise initially generated. These devices 200 may include user devices, organization devices, customer devices, and the like and/or combinations thereof. In one example, devices 200 may include devices of a financial institution, other private companies, a government organization, an educational organization and the like. In other examples, devices 200 may include public devices such as library terminals, ATMs, and the like. Tasks may be requested and/or generated through such devices using one or more applications executing on devices 200. Additionally or alternatively, devices 200 may include task processing management devices or systems configured to coordinate, manage, and monitor the completion of tasks. In one or more examples, tasks may be generated or requested through one or more applications executing on devices 200 or components (other software, firmware, hardware) of devices 200.

When tasks are requested, they may be executed or otherwise performed on the device itself or one or more servers may be involved. For example, as illustrated in FIG. 2A, the system may include one or more servers 205 (e.g., proxy servers, cloud servers, etc.). These servers 205 may be remotely located from devices 200, and require communication through a communication network such as a cellular network, broadband network, telephone network, satellite network, and the like and/or combinations thereof. Each of the servers 205 may include processors, memory, and/or other hardware or software to provide various functionality and capabilities. Servers 205 may have the same or different functionalities and capabilities as needed or desired. Accordingly, in some arrangements, when a task or particular type of task is requested through devices 200, those tasks or portions of those tasks may be transmitted to one or more of servers 205 for processing and completion. For example, if a task is divided into sub-tasks, at least some of those sub-tasks may be transmitted to one or more of servers 205 for execution. Meanwhile, one or more of devices 200 may monitor and manage the progress and completion of the overall task.

Additionally, the network architecture may further include one or more databases 210 configured to house data that may be used in processing tasks. Accordingly, in the process of executing a task, one or more of servers 205 and/or devices 200 may obtain, request, or retrieve data from databases 210 to facilitate the processing of tasks. In some arrangements, the collection or obtaining of data may be a sub-task of an overall task to be processed, and one or more of databases 210 may correspond to an intended destination of a transport container or receptacle through which the sub-task is transmitted. In some arrangements, the system may optionally include one or more load balancers 215 that may help to coordinate which servers, databases, or other network devices receive various communications, requests, processing tasks, and the like.

FIG. 2B illustrates a process flow in which an initial task represented by block 230 is requested by a source such as a computer application, a user, a network entity and the like. The requested task 230 may be inputted into a sub-task creator module 235 to identify and generate sub-tasks 240. As discussed herein, the use of sub-tasks 240 may provide greater reliability and efficiency in the processing of the overall task. These sub-tasks 240 may then be inputted into a sub-task spawning module 245 such as transport module 112c (FIG. 1B) in order to create multiple transport receptacles 250, each carrying a copy or instance of the same sub-task. In some arrangements, the spawning module 245 may assign a different and/or unique identifier to each copy or instance of the same sub-task and/or to each receptacle carrying those copies. For example, copies of the same sub-task (and/or the receptacles in which they are carried) may be identified as “subtask123a,” “subtask123b,” “subtask123c,” and so on, or the like. This allows the spawning module 245 and other parts of the management system to individually monitor and control each copy of a particular sub-task.

Once the separate receptacles and copies or instances of a sub-task are created and stored, those receptacles 250 may be provided to a sub-task transport module 255 that is configured to determine a route for each receptacle and transmit those receptacles through the determined route to an intended destination device. In some examples, the intended destination might already be defined by the spawning module 245 (e.g., specified in the receptacles 250). In other instances, the transport module 255 may determine and specify the destination device or node upon receiving the created receptacles 250. According to some arrangements, each copy of the same sub-task might have different destinations if multiple devices, systems, modules and/or nodes in the network are capable of completing the sub-task. The selection of a capable destination may also be randomized. Alternatively, the selection of a destination may be performed based on various factors including load balancing, computing power of the destination device, computing power required or desired for the sub-task, network latency between the source and the destination, and the like and/or combinations thereof.

Once the routes (or initial portions of the routes) for each receptacle has been defined, those receptacles 250 may be transmitted to their intended destinations 260. Again, the routes that the receptacles 250 take to their intended destinations 260 may be randomized (e.g., assigned in a non-deterministic manner) in some examples. According to one or more aspects, it might only be necessary or desired for one of the receptacles 250 (carrying the same sub-task) to be processed. In other words, it might not be necessary or desirable to perform the same sub-task multiple times or by multiple devices or systems. Accordingly, upon determining that one of the receptacles 250 carrying the sub-task has been received by one of the destinations 260, one or more or all of the other receptacles 250 or copies of the sub-task may be deleted. For example, the sub-task creator module 235 (or another module) may transmit a command, upon receiving confirmation that one of the receptacles 250 carrying a copy of the sub-task has been successfully received, to the destinations 260 requesting or instructing deletion of all other copies of the sub-task. Because each instance of the sub-task or receptacle carrying the same sub-task may be differently and/or uniquely identified, the sub-task creator module 235 may insure that the correct copies are deleted. In some cases, deletion might only be instructed or occur upon determining that the one copy of the sub-task has been successfully completed or processed.

One or more of destination devices or systems 260 may be capable of processing multiple types of tasks or sub-tasks either in parallel or sequentially. Accordingly, in some examples, multiple tasks or sub-tasks may be transmitted to one or more of destinations 260, allowing the one or more destinations 260 to manage the processing of those tasks and/or sub-tasks. In some cases, priority may be designated among the tasks or sub-tasks by the source of the task or sub-task.

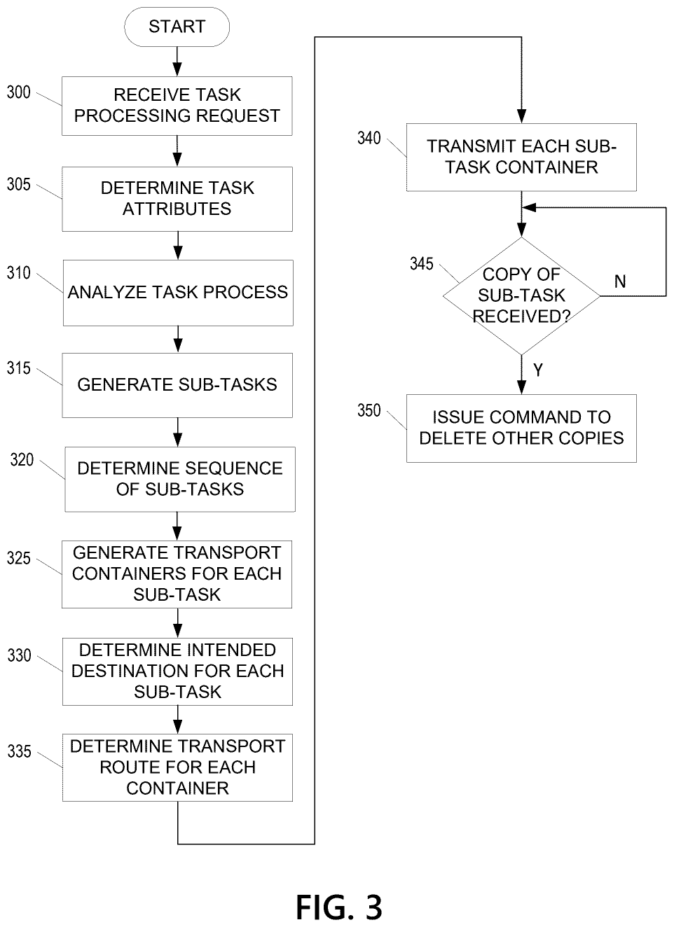

FIG. 3 is a flowchart illustrating an example method by which a computer task processing system such as task processing management system 110 (FIG. 1) may coordinate and manage efficient and secure processing of requested tasks in a network environment. In step 300, the computer task processing system may receive or detect a request for processing of a computerized task. As discussed herein, computerized tasks may include a wide range of task types, including network processes, device maintenance tasks, computer modelling processes, simulations, financial transaction processing, security monitoring and processing, and the like and/or combinations thereof. Upon receiving or detecting the task request, the computer task processing system may determine various attributes of the task in step 305. Such attributes may include a task identifier, a requesting device, a requesting device address (e.g., IP address), a requesting user identifier, a type of task requested, a priority level of the task, and the like. In one or more arrangements, determining the task attributes may include extracting task instructions or computer-executable task code (e.g., JAVASCRIPT, JAVA, C#, PYTHON, etc.). For example, the task request may include the process, instructions, steps, and/or executable code for the task processes that are needed or requested. Accordingly, the computer task processing system may separate the instructions or code from other information provided as part of the request.

In step 310, the task processing system may analyze the task process (e.g., the executable task code or instructions) to identify points in the code or instructions that may be used for dividing the task into multiple sub-tasks. In some arrangements, the task processing system may parse the code or instructions to search for a particular delineator such as a phrase, word, symbol, sequence of characters, and the like, and/or combinations thereof. For example, the task processing system may look for a delineator “#task1,” “#task2,” etc. In other arrangements or examples, the task processing system may parse the task process to determine processing (e.g., computational) loads required for various segments or portions of the task process and/or code. Accordingly, in some examples, the task processing system may determine or identify segmentation points in the process or code based on balancing the processing loads of each sub-task. In still other examples, the task processing system may identify instructions or code segmentation points based on a number of lines of instructions or code.

In step 315, the task processing system may generate multiple sub-tasks based on the identified segmentation points. Generating a sub-task may include generating a new or separate file or other data structure that includes a portion of the instructions or code of the requested task. That file or data structure may be separately executable from the instructions or code of the requested task. Each sub-task may be a proper sub-set of the instructions or code of the overall requested task. In one or more examples, every portion of code or instructions in the task may be included in at least two sub-tasks. In other words, sub-tasks may include overlapping code or instruction segments, but also include different other segments of the code or instructions. This may further insure that every part of the task is processed. This technique may further serve as a redundancy check to make sure the result of the processing is correct or consistent across multiple iterations. Additionally, each sub-task may be assigned a different and unique identifier.

In step 320, the task processing system may determine a sequence of the sub-tasks. For example, the task processing system may determine whether one sub-task must be performed before another sub-task. The task processing system may make this determination based on whether one sub-task requires the output of another sub-task. If so, then the one sub-task may be required to be performed after the other sub-task has completed processing and an output received.

In step 325, the task processing system may, for each sub-task, generate multiple transport containers or receptacles for transmitting the sub-task to a destination device, system, node, or module configured to process that sub-task. For example, a transport container may correspond to one or more network packets. As discussed above, providing multiple copies or instances of each sub-task may help to ensure that that sub-task is processed or completed. If only one instance of the sub-task is transmitted to a processing destination, and if a network link through which that sub-task is transmitted fails, the sub-task may need to be retransmitted. This retransmission may result in delays and inefficiencies in the processing of the overall requested task.

Additionally, in generating the multiple transport containers, the task processing system may assign a unique identifier to each transport container so that each instance or copy of the sub-task can be differentiated based on the transport container identifier. Additionally or alternatively, the task processing system may assign a unique identifier to each copy or instance of the sub-task (e.g., different from the sub-task identifier).

According to one or more arrangements, the task processing system may further determine a number of receptacles (and thus, instances or copies of the same sub-task) to generate as part of step 325. This determination may account for various factors such as existing or expected network conditions (e.g., network congestion), number of available task processing servers, security required for the task, and the like and/or combinations thereof. For example, if there is high network congestion, more copies of the same sub-task may be generated. In another example, if a security level required for the task is high, less copies or instances may be used. In yet another example, if the number of available (and capable) task processing servers is 3, the number of receptacles may be a multiple of that number, i.e., 3 (e.g., 3, 6, 9, etc.), or some other number calculated based on the number of available servers for processing that sub-task.

In step 330, for each sub-task, the task processing system may further determine an intended destination for each transport container of the sub-task. For example, different devices, systems, nodes, or modules may have different capabilities or functionality, including software, hardware, firmware and the like. Accordingly, not every network system may be capable of or configured to process every type of sub-task, and the task processing system may determine which network devices, systems, modules, or nodes are able to process the sub-task. In some examples, the task processing system may also select a network destination based on other criteria, such as a current processing load of a network destination, a geographic location of a network destination, an affiliation of the network destination (e.g., internal, external, etc.), and the like and/or combinations thereof.

In step 335, the task processing system may determine and specify a transport route for each transport container. In some examples, the transport route may be randomly assigned or otherwise specified in a non-deterministic manner. This may have multiple benefits including allowing each transport container of a sub-task to travel different routes thereby improving the chances that at least one instance of the sub-task is successfully received at the intended destination. Another benefit may be enhanced security, since the source might not have a defined algorithm or might not have predetermined knowledge of the route the transport container will take. In determining a random transport route, the task processing system may specify an intended destination and randomly select a next hop along a path that will reach the intended destination. In other examples, determining a transport route might not be random. Instead, a transport route may be assigned based one or more algorithms that accounts for various factors such as load balancing.

Specifying the transport route may include storing route information into the transport container. For example, the route information may include the address of the intended destination, as well as an address of a next hop. In some examples, an entire route (e.g., all intermediate nodes) from source to destination may be identified in the container. In other examples, the task processing system may include a flag or other indicator in the container that specifies that a random route is to be used. This flag or other indicator may be read or detected by the next hop or node, at which point that hop or node may randomly select the next hop or node along a path to the intended destination.

In step 340, the task processing system may transmit the transport containers to the next node in the transport route to ultimately reach the intended destination. In step 345, the task processing system may monitor, for each sub-task, whether an instance or copy of that sub-task (i.e., one of the transport containers for that sub-task) has been successfully received by the intended destination. In one example, the task processing system may request an acknowledgment from each intended destination of the transmitted transport containers. Additionally or alternatively, each destination device, system, module, or node may be configured to automatically transmit an acknowledgment back to the sender (i.e., the task processing system) to acknowledge receipt of a communication.

In step 350, upon determining that the at least one transport container of a sub-task has been received by its intended destination, the task processing system may issue a command to delete all other transport containers and corresponding instances of that same sub-task. In one example, the task processing system may issue a command that includes all transport container or sub-task instance identifiers that are to be deleted. In another example, the task processing system may issue a command that includes the transport container or sub-task instance identifier that was successfully received. This may, in turn, cause the destination devices to recognize that all other instances of that same sub-task (identifiable based on the sub-task identifier (rather than the sub-task instance identifier)) are to be deleted or otherwise not processed. By deleting or otherwise not processing the other instances, processing power and computational load may be reduced for the various devices, systems, methods, and nodes in the networked system. In some arrangements, the task processing system might only send a deletion command upon determining that an instance of the sub-task has been completed, rather than just received. During this time, the task processing system may issue a pause or hold command for the other instances of that same sub-task. This may ensure that the sub-task is actually performed and finished before deleting all other instances of the sub-task.

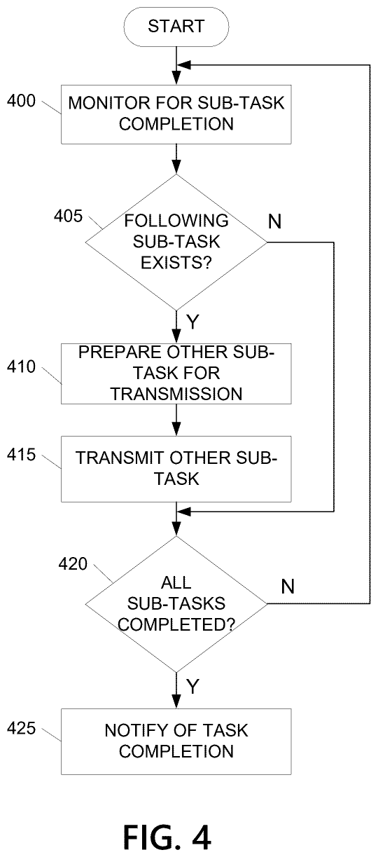

FIG. 4 illustrates an example method for monitoring the completion of sub-tasks and managing the transmission of sub-tasks according to a specified sequence. This process may be performed upon receiving a requested task (e.g., step 300 of FIG. 3) and/or upon transmitting the first sub-task or sub-tasks of the requested task. In step 400, the task processing system may, after receiving an acknowledgment that an instance of a sub-task has been received, monitor for the completion of that instance of the sub-task. For example, a destination device, system, module, or node may be instructed or configured to transmit a completion message to the task processing system upon completing a sub-task. In some examples, the completion message may include an output (e.g., data, a result, etc.) of the sub-task process.

In step 405, upon receiving a completion message for a first sub-task, the task processing system may determine whether there is a second sub-task that must follow sequentially after the first sub-task. For example, if a second sub-task requires, as input, the output or result of the first sub-task, the second sub-task might need to be performed after completion of the first sub-task. Accordingly, the task processing system might not transmit the second sub-task until receiving the output and completion notification of the first sub-task. In some instances, there may be multiple other sub-tasks that must follow completion of the first sub-task. The task processing system may thus be configured to identify or otherwise determine each of those other sub-tasks.

In step 410, the task processing system may prepare the one or more second sub-tasks for transmission to a destination processing system, device, module, or node (e.g., steps 325-335 of FIG. 3). The task processing system may then transmit the one or more second sub-tasks in step 415 (e.g., similar to steps 340-350 of FIG. 3).

In step 420, the task processing system may further determine whether all sub-tasks for a requested overall task have been completed. For example, the task processing system may determine whether a last sub-task in the determined sequence (e.g., step 320) has been completed and a result or confirmation received. In another example, the task processing system may confirm or otherwise determine whether all sub-tasks have been completed (and results received). If all sub-tasks are determined to be complete, the task processing system may notify a requesting system or user that the task has been completed in step 425. In some examples, the notification may include a result of the processing.

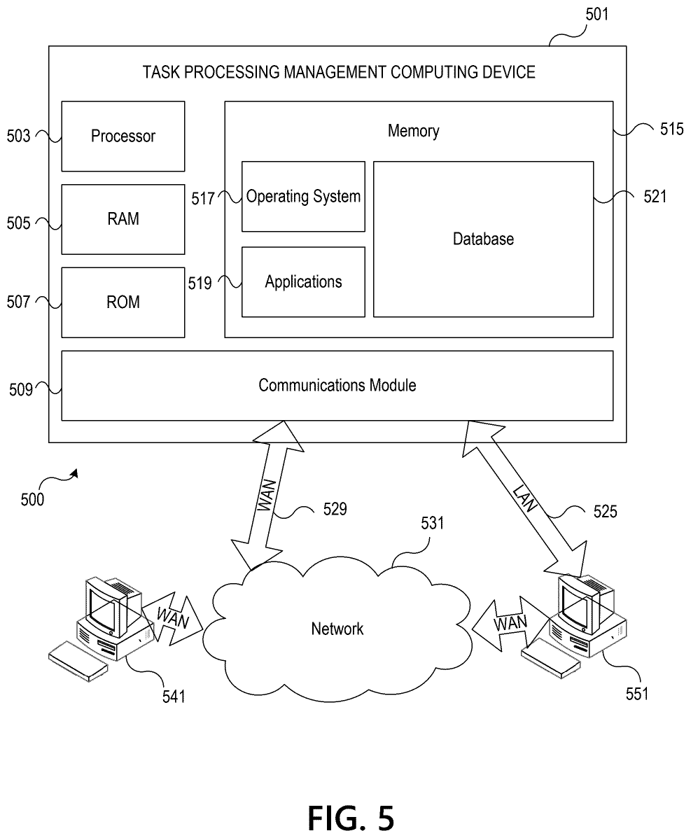

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include task processing management computing device 501 having processor 503 for controlling overall operation of task processing management computing device 501 and its associated components, including Random Access Memory (RAM) 505, Read-Only Memory (ROM) 507, communications module 509, and memory 515. Task processing management computing device 501 may include a variety of computer readable media. Computer readable media may be any available media that may be accessed by speech and text analysis computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by speech and text analysis computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on task processing management computing device 501. Such a processor may execute computer-executable instructions stored on a computer-readable medium.

Software may be stored within memory 515 and/or storage to provide instructions to processor 503 for enabling task processing management computing device 501 to perform various functions as discussed herein. For example, memory 515 may store software used by speech and text analysis computing device 501, such as operating system 517, application programs 519, and associated database 521. Also, some or all of the computer executable instructions for task processing management computing device 501 may be embodied in hardware or firmware. Although not shown, RAM 505 may include one or more applications representing the application data stored in RAM 505 while task processing management computing device 501 is on and corresponding software applications (e.g., software tasks) are running on task processing management computing device 501.

Communications module 509 may include a microphone, keypad, touch screen, and/or stylus through which a user of task processing management computing device 501 may provide input, and may also include one or more of a speaker for providing audio output and a video display device for providing textual, audiovisual and/or graphical output. Computing system environment 500 may also include optical scanners (not shown).

Task processing management computing device 501 may operate in a networked environment supporting connections to one or more other computing devices, such as computing device 541 and 551. Computing devices 541 and 551 may be personal computing devices or servers that include any or all of the elements described above relative to task processing management computing device 501.

The network connections depicted in FIG. 5 may include Local Area Network (LAN) 525 and Wide Area Network (WAN) 529, as well as other networks. When used in a LAN networking environment, task processing management computing device 501 may be connected to LAN 525 through a network interface or adapter in communications module 509. When used in a WAN networking environment, task processing management computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A method comprising:
determining, by a task processing computing device, information for a computerized task to be performed by one or more computing devices;
identifying, by the task processing computing device, a plurality of sub-tasks within the computerized task, wherein each of the sub-tasks is required to be completed prior to completion of the computerized task;
for each of the plurality of sub-tasks, the task processing computing device:
generating multiple network transport receptacles for the sub-task;
determining a transport path for each of the network transport receptacles, the transport paths being determined individually without regard to a transport path of any other network transport receptacle for the sub-task;
transmitting, through the corresponding transport path, the network transport receptacles to one or more computing devices configured to perform the sub-task;
determining whether any of the multiple network transport receptacles has reached the one or more computing devices; and
in response to determining that one of the multiple network transport receptacles has reached the one or more computing devices, causing all other network transport receptacles other than the one of the multiple network transport receptacles to be deleted.

2. The method of claim 1, wherein the multiple network transport receptacles include a first network transport receptacle and a second network transport receptacle,
wherein determining whether any of the multiple network transport receptacles has reached the one or more computing devices includes:
receiving an indication that at least one of the one or more computing devices that the first network transport receptacle has been received prior to receiving any indication of receipt of the second network transport receptacle by any of the one or more computing devices, and
wherein causing all other multiple network transport receptacles other than the one of the multiple network transport receptacles to be deleted includes deleting the second network transport receptacle in response to receiving the indication that at least one of the one or more computing devices that the first network transport receptacle has been received.

3. The method of claim 2, wherein causing all other multiple network transport receptacles other than the one of the multiple network transport receptacles to be deleted includes transmitting a deletion command to the one or more computing devices identifying the other multiple network transport receptacles other than the one of the multiple network transport receptacles

4. The method of claim 1, wherein determining a transport path for each of the network transport receptacles includes:
specifying, in at least one of the multiple network transport receptacles, that the transport path is to be randomized.

5. The method of claim 1, further comprising:
receiving an indication that a first sub-task of the plurality of sub-tasks has been completed; and
in response to receiving the indication:
generating multiple network transport receptacles for a second sub-task of the plurality of sub-tasks;
determining a transport path for each of the network transport receptacles for the second sub-task, the transport paths being determined individually without regard to a transport path of any other network transport receptacle for the second sub-task; and
transmitting, through the corresponding transport path, the network transport receptacles for the second sub-task to the one or more computing devices.

6. The method of claim 1, wherein the multiple network transport receptacles for each sub-task is transmitted in parallel to the one or more computing devices.

7. The method of claim 1, wherein the multiple network transport receptacles for each sub-task is transmitted sequentially to the one or more computing devices

8. An apparatus comprising:
a processor; and
memory storing computer-readable instructions that, when executed, cause the apparatus to:
determine information for a computerized task to be performed by one or more computing devices;
identify a plurality of sub-tasks within the computerized task, wherein each of the sub-tasks is required to be completed prior to completion of the computerized task;
for each of the plurality of sub-tasks:
generate multiple network transport receptacles for the sub-task;
determine a transport path for each of the network transport receptacles, the transport paths being determined individually without regard to a transport path of any other network transport receptacle for the sub-task;
transmit, through the corresponding transport path, the network transport receptacles to one or more computing devices configured to perform the sub-task;
determine whether any of the multiple network transport receptacles has reached the one or more computing devices; and
in response to determining that one of the multiple network transport receptacles has reached the one or more computing devices, cause all other network transport receptacles other than the one of the multiple network transport receptacles to be deleted.

9. The apparatus of claim 8, wherein the multiple network transport receptacles include a first network transport receptacle and a second network transport receptacle,
wherein determining whether any of the multiple network transport receptacles has reached the one or more computing devices includes:
receiving an indication that at least one of the one or more computing devices that the first network transport receptacle has been received prior to receiving any indication of receipt of the second network transport receptacle by any of the one or more computing devices, and
wherein causing all other multiple network transport receptacles other than the one of the multiple network transport receptacles to be deleted includes deleting the second network transport receptacle in response to receiving the indication that at least one of the one or more computing devices that the first network transport receptacle has been received.

10. The apparatus of claim 9, wherein causing all other multiple network transport receptacles other than the one of the multiple network transport receptacles to be deleted includes transmitting a deletion command to the one or more computing devices identifying the other multiple network transport receptacles other than the one of the multiple network transport receptacles

11. The apparatus of claim 8, wherein determining a transport path for each of the network transport receptacles includes:
specifying, in at least one of the multiple network transport receptacles, that the transport path is to be randomized.

12. The apparatus of claim 8, wherein the instructions, when executed, further cause the apparatus to:
receive an indication that a first sub-task of the plurality of sub-tasks has been completed; and
in response to receiving the indication:
generate multiple network transport receptacles for a second sub-task of the plurality of sub-tasks;
determine a transport path for each of the network transport receptacles for the second sub-task, the transport paths being determined individually without regard to a transport path of any other network transport receptacle for the second sub-task; and
transmit, through the corresponding transport path, the network transport receptacles for the second sub-task to the one or more computing devices.

13. The apparatus of claim 8, wherein the multiple network transport receptacles for each sub-task is transmitted in parallel to the one or more computing devices.

14. The apparatus of claim 8, wherein the multiple network transport receptacles for each sub-task is transmitted sequentially to the one or more computing devices.

15. A non-transitory computer-readable medium storing computer-readable instructions that, when executed, cause an apparatus to:
determine information for a computerized task to be performed by one or more computing devices;
identify a plurality of sub-tasks within the computerized task, wherein each of the sub-tasks is required to be completed prior to completion of the computerized task;
for each of the plurality of sub-tasks:
generate multiple network transport receptacles for the sub-task;
determine a transport path for each of the network transport receptacles, the transport paths being determined individually without regard to a transport path of any other network transport receptacle for the sub-task;
transmit, through the corresponding transport path, the network transport receptacles to one or more computing devices configured to perform the sub-task;
determine whether any of the multiple network transport receptacles has reached the one or more computing devices; and
in response to determining that one of the multiple network transport receptacles has reached the one or more computing devices, cause all other network transport receptacles other than the one of the multiple network transport receptacles to be deleted.

16. The non-transitory computer-readable medium of claim 15, wherein the multiple network transport receptacles include a first network transport receptacle and a second network transport receptacle,
wherein determining whether any of the multiple network transport receptacles has reached the one or more computing devices includes:
receiving an indication that at least one of the one or more computing devices that the first network transport receptacle has been received prior to receiving any indication of receipt of the second network transport receptacle by any of the one or more computing devices, and
wherein causing all other multiple network transport receptacles other than the one of the multiple network transport receptacles to be deleted includes deleting the second network transport receptacle in response to receiving the indication that at least one of the one or more computing devices that the first network transport receptacle has been received.

17. The non-transitory computer-readable medium of claim 15, wherein causing all other multiple network transport receptacles other than the one of the multiple network transport receptacles to be deleted includes transmitting a deletion command to the one or more computing devices identifying the other multiple network transport receptacles other than the one of the multiple network transport receptacles

18. The non-transitory computer-readable medium of claim 15, wherein determining a transport path for each of the network transport receptacles includes:
specifying, in at least one of the multiple network transport receptacles, that the transport path is to be randomized.

19. The non-transitory computer-readable medium of claim 15, wherein the instructions, when executed, further cause the apparatus to:
receive an indication that a first sub-task of the plurality of sub-tasks has been completed; and
in response to receiving the indication:
generate multiple network transport receptacles for a second sub-task of the plurality of sub-tasks;
determine a transport path for each of the network transport receptacles for the second sub-task, the transport paths being determined individually without regard to a transport path of any other network transport receptacle for the second sub-task; and
transmit, through the corresponding transport path, the network transport receptacles for the second sub-task to the one or more computing devices.

20. The non-transitory computer-readable medium of claim 15, wherein the multiple network transport receptacles for each sub-task is transmitted in parallel to the one or more computing devices.
